(19) United States
(12) Patent Application Publication
(10) Pub. No.: US 2008/0057872 A1
(43) Pub. Date: Mar. 6, 2008

(54) METHOD AND DEVICE FOR BINDING IN A BUILDING AUTOMATION SYSTEM

(75) Inventors: Norman R. McFarland, Palatine, IL (US); Geoffrey D. Nass, Rolling Meadows, IL (US); Pornsak Songkakul, Mequon, WI (US); Jeffrey A. Raimo, Winnetka, IL (US); John A. Hendrix, Grayslake, IL (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Building Technologies, Inc.

(21) Appl. No.: 11/846,137

(22) Filed: Aug. 28, 2007

Related U.S. Application Data
(60) Provisional application No. 60/823,794, filed on Aug. 29, 2006.

(51) Int. Cl. H04B 7/00

(52) U.S. Cl. 455/66.1

(57) ABSTRACT

An automation component configured for wireless communication within a building automation system is disclosed. The automation component includes a wireless communications component, a processor in communications with the wireless communications component and a memory in communication with the processor, the memory configured to stored computer readable instructions which are executable by the processor. The computer readable instructions are programmed to generate a binding request including a device identifier, broadcast the binding request via the wireless communications component, and establish a binding relationship based on a received response to the binding request. A method for binding an automation component within a building automation system is further disclosed. The method includes communicating a binding request via a wireless communication link wherein the binding request includes a device identifier, receiving a binding response via the wireless communication link, and establishing a binding relationship based on the received binding response.

### CROSS REFERENCE TO RELATED APPLICATIONS

This patent claims the priority benefit under 35 U.S.C. §119(e) of U.S. provisional patent application Ser. No. 60/823,794, filed on Aug. 29, 2006, entitled “AUTOMATIC BINDING OF WIRELESS DEVICES IN A BUILDING AUTOMATION SYSTEM” (2006P17490US), the content of which is incorporated herein in its entirety for all purposes.

### BACKGROUND

The present disclosure generally relates to building automation systems. In particular, the present disclosure relates to methods and devices for binding or linking automation components within a building automation system.

A building automations system (BAS) typically integrates and controls elements and services within a structure such as the heating, ventilation and air conditioning (HVAC) system, security services, fire systems and the like. The integrated and controlled systems are arranged and organized into one or more floor level networks (FLNs) containing application or process specific controllers, sensors, actuators, or other devices distributed or wired to form a network. The floor level networks provide general control for a particular floor or region of the structure. For example, a floor level network may be an RS-485 compatible network that includes one or more controllers or application specific controllers configured to control the elements or services within floor or region. The controllers may, in turn, be configured to receive an input from a sensor or other device such as, for example, a temperature sensor (RTS) deployed to monitor the floor or region. The input, reading or signal provided to the controller, in this example, may be a temperature indication representative of the physical temperature. The temperature indication can be utilized by a process control routine such as a proportional-integral control routine executed by the controller to drive or adjust a damper, heating element, cooling element or other actuator towards a predefined set-point.

Information such as the temperature indication, sensor readings and/or actuator positions provided to one or more controllers operating within a given floor level network may, in turn, be communicated to an automation level network (ALN) or building level network (BLN) configured to, for example, execute control applications, routines or loops, coordinate time-based activity schedules, monitor priority based overrides or alarms and provide field level information to technicians. Building level networks and the included floor level networks may, in turn, be integrated into an optional management level network (MLN) that provides a system for distributed access and processing to allow for remote supervision, remote control, statistical analysis and other higher level functionality. Examples and additional information related to BAS configuration and organization may be found in the co-pending U.S. patent application Ser. No. 11/590,157 (2006P18573 US), filed on Oct. 31, 2006, and co-pending U.S. patent application Ser. No. 10/915,034 (2004P13093 US), filed on Aug. 8, 2004, the contents of these applications are hereby incorporated by reference for all purposes.

Wireless devices, such as devices that comply with IEEE 802.15.4/ZigBee protocols, may be implemented within the control scheme of a building automation system without incurring additional wiring or installation costs. ZigBee-compliant devices such as full function devices (FFD) and reduced function devices (RFD) may be interconnected to provide a device net or mesh within the building automation system. For example, full function devices are designed with the processing power necessary to establish peer-to-peer connections with other full function devices and/or execute control routines specific to a floor or region of a floor level network. Each of the full function devices may, in turn, communicate with one or more of the reduced function devices in a hub and spoke arrangement. Reduced function devices such as the temperature sensor described above are designed with limited processing power necessary to perform a specific task(s) and communicate information directly to the connected full function device.

Wireless devices for use within the building automation system must be configured in order to establish communications with the different elements, components and networks that comprise the building automation system. Systems and method for configuring and establishing communications between the wireless devices and the automation components may be desirable and facilitate the setup, configuration, maintenance and operation of the building automation system.

### SUMMARY

The present disclosure generally provides for binding wireless devices and/or automation components operating within a building automation system (BAS). Wireless devices and/or automation components need to be bound in order to communicate with each other. Generally the disclosed devices and methods are configured to wirelessly communicate information, identifiers and requests configured to establish binding relationships there between.

In one embodiment, an automation component configured for wireless communication within a building automation system is disclosed. The automation component includes a wireless communications component, a processor in communication with the wireless communications component and a memory in communication with the processor, the memory configured to stored computer readable instructions which are executable by the processor. The computer readable instructions are programmed to generate a binding request including a device identifier, broadcast the binding request via the wireless communications component, and establish a binding relationship based on a received response to the binding request.

In another embodiment, a method for binding an automation component within a building automation system is further disclosed. The method includes communicating a binding request via a wireless communication link wherein the binding request includes a device identifier, receiving a binding response via the wireless communication link, and establishing a binding relationship based on the received binding response.

In another embodiment, an automation component configured for wireless communication within a building automation system is disclosed. The automation component includes a processor configured to generate a binding request including a device identifier, a wireless transmitter configured to wirelessly broadcast the binding request to a second automation component, and a receiver configured to receive a binding response communicated from the second automation component, wherein a binding relationship is established with the second automation component based on the received response.

Additional features and advantages of the present invention are described in, and will be apparent from, the following Detailed Description and the figures.

### BRIEF DESCRIPTION OF THE FIGURES

The method, system and teaching provided relate to binding automation components within a building automation system (BAS).

FIG. 1 illustrates an embodiment of a building automation system configured in accordance with the disclosure provided herein;

FIG. 2 illustrates an embodiment of a wireless device or automation component that may be utilized in connection with the building automation system shown in FIG. 1;

FIG. 3 illustrates an exemplary flowchart representative of an exemplary binding operation; and

FIG. 4 illustrates an exemplary flowchart representative of a binding operation that may be implemented in connection with the building automation system shown in FIG. 1.

### DETAILED DESCRIPTION

The embodiments discussed herein include automation components,wireless devices and transceivers. The devices may be IEEE 802.15.4/ZigBee-compliant automation components such as: a personal area network (PAN) coordinator which may be implemented as a field panel transceivers (FPX); a full function device (FFD) implemented as a floor level device transceiver (FLNX); and a reduced function device (RFD) implemented as a wireless room temperature sensor (WRTS) that may be utilized in a building automation system (BAS). The devices identified herein are provided as an example of automation components, wireless devices and transceivers that may be integrated and utilized within a building automation system embodying the teachings disclosed herein and are not intended to limit the type, functionality and interoperability of the devices and teaching discussed and claimed herein.

### I. Building Automation System Overview

One exemplary building automation system that may include the devices and be configured as described above is the APOGEE® system provided by Siemens Building Technologies, Inc. The APOGEE® system may implement RS-485 wired communications, Ethernet, proprietary and standard protocols, as well as known wireless communications standards such as, for example, IEEE 802.15.4 wireless communications which are compliant with the ZigBee standards and/or ZigBee certified wireless devices or automation components. ZigBee standards, proprietary protocols or other standards are typically implemented in embedded applications that may utilize low data rates and/or require low power consumption. Moreover, ZigBee standards and protocols are suitable for establishing inexpensive, self-organizing, mesh networks which may be suitable for industrial control and sensing applications such as building automation. Thus, automation components configured in compliance with ZigBee standards or protocols may require limited amounts of power allowing individual wireless devices, to operate for extended periods of time on a finite battery charge.

The wired or wireless devices such as the IEEE 802.15.4/ZigBee-compliant automation components may include, for example, an RS-232 connection with an RJ11 or other type of connector, an RJ45 Ethernet compatible port, and/or a universal serial bus (USB) connection. These wired, wireless devices or automation components may, in turn, be configured to include or interface with a separate wireless transceiver or other communications peripheral thereby allowing the wired device to communicate with the building automation system via the above-described wireless protocols or standards. Alternatively, the separate wireless transceiver may be coupled to a wireless device such as a IEEE 802.15.4/ZigBee-compliant automation component to allow for communications via a second communications protocol such as, for example, 802.11x protocols (802.11a, 802.11b . . . 802.11n, etc.) These exemplary wired, wireless devices may further include a man-machine interface (MMI) such as a web-based interface screen that provide access to configurable properties of the device and allow the user to establish or troubleshoot communications between other devices and elements of the BAS.

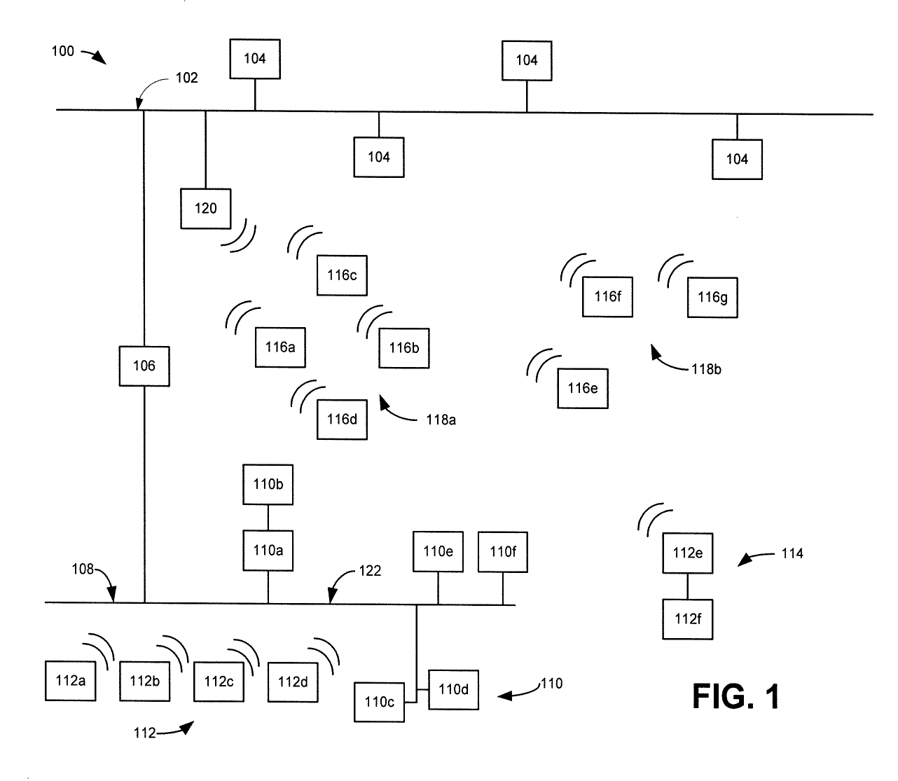

FIG. 1 illustrates an exemplary building automation system or control system 100 that may incorporate the methods, systems and teaching provided herein. The control system 100 includes a first network 102 such as an automation level network (ALN) or management level network (MLN) in communication with one or more controllers such as a plurality of terminals 104 and a modular equipment controller (MEC) 106. The modular equipment controller or controller 106 is a programmable device which may couple the first network 102 to a second network 108 such as a floor level network (FLN). The second network 108, in this exemplary embodiment, may include a wired network 122 that connects to building automation components 110 (individually identified as automation components 110a to 110f). The second network 108 may further be coupled to wireless building automation components 112. For example, the building automation components 112 may include wireless devices individually identified as automation components 112a to 112f. In one embodiment, the automation component 112f may be a wired device that may or may not include wireless functionality and connects to the automation component 112e. In this configuration, the automation component 112f may utilize or share the wireless functionality provided by the automation component 112e to define an interconnected wireless node 114.

The control system 100 may further include automation components generally identified by the reference numerals 116a to 116g. The automation components 116a to 116g may be configured or arranged to establish one or more networks or subnets 118a and 118b. The automation components 116a to 116g such as, for example, full or reduced function devices and/or a configurable terminal equipment controller (TEC), cooperate to wirelessly communicate information between the second network 108, the control system 100 and other devices within the mesh networks or subnets 118a and 118b. For example, the automation component 116a may communicate with other automation components 116b to 116d within the mesh network 118a by sending a message addressed to the network identifier, alias and/or media access control (MAC) address assigned to each of the interconnected automation components 116a to 116g and/or to a field panel 120. In one configuration, the individual automation components 116a to 116d within the subnet 118a may communicate directly with the field panel 120 or, alternatively, the individual automation components 116a to 116d may be configured in a hierarchal manner such that only one of the components for example, automation component 116c, communicates with the field panel 120. The automation components 116e to 116g of the mesh network 118b may, in turn, communicate with the individual automation components 116a to 116d of the mesh network 118a or the field panel 120.

The automation components 112e and 112f defining the wireless node 114 may wirelessly communicate with the second network 108, and the automation components 116e to 116g of the mesh network 118b to facilitate communications between different elements, section and networks within the control system 100. Wireless communication between individual the automation components 112, 116 and/or the subnets 118a, 118b may be conducted in a direct or point-to-point manner, or in an indirect or routed manner through the nodes or devices comprising the nodes or networks 102, 108, 114 and 118. In an alternate embodiment, the wired network 122 is not provided, and further wireless connections may be utilized.

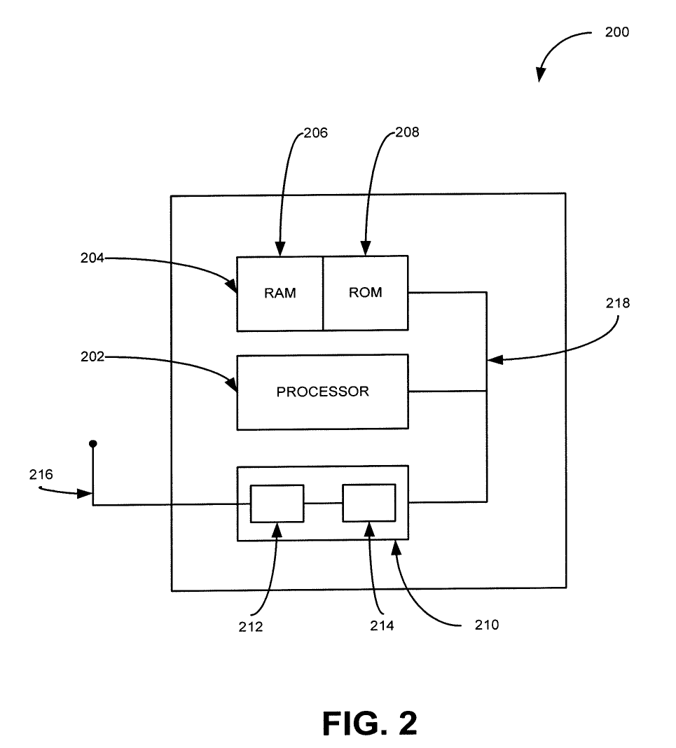

FIG. 2 illustrates an exemplary automation component 200 that may be utilized within the control system 100. The automation component 200 maybe be a full function device or a reduced function device and may be utilized interchangeably with the automation components 110, 112 and 116 shown and discussed in connection with FIG. 1. The automation component 200 in this exemplary embodiment may include a processor 202 such as an INTEL® PENTIUM class processor in communication with a memory 204 or storage medium. The memory 204 or storage medium may contain random access memory (RAM) 206, flashable or non-flashable read only memory (ROM) 208 and/or a hard disk drive (not shown), or any other known or contemplated storage device or mechanism. The automation component may further include a communications component 210. The communications component 210 may include, for example, the ports, hardware and software necessary to implement wired communications with the control system 100. The communications component 210 may alternatively, or in addition to, contain a wireless transmitter 212 and a receiver 214 communicatively coupled to an antenna 216 or other broadcast hardware.

The sub-components 202, 204 and 210 of the exemplary automation component 200 may be coupled and able to share information with each other via a communications bus 218. In this way, computer readable instructions or code such as software or firmware may be stored on the memory 204. The processor 202 may read and execute the computer readable instructions or code via the communications bus 218. The resulting commands, requests and queries may be provided to the communications component 210 for transmission via the transmitter 212 and the antenna 216 to other automation components 200, 112 and 116 operating within the first and second networks 102 and 108.

### II. Automation Component Binding

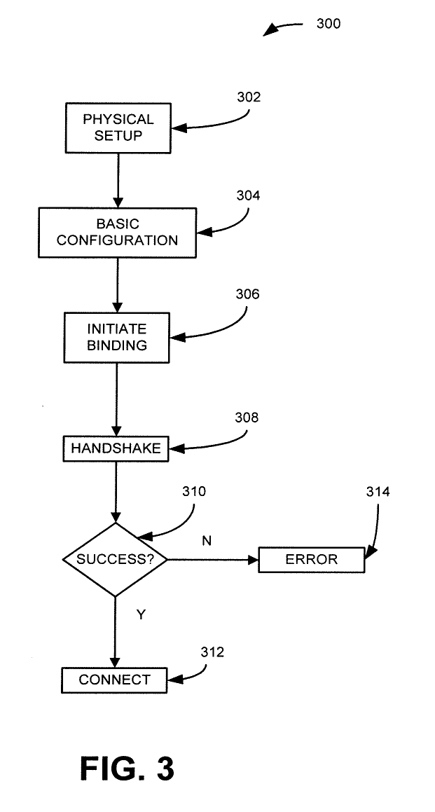

FIG. 3 illustrates an overview of a wireless binding operation or procedure 300 that may be implemented between one or more of the exemplary automation components 200 (see FIG. 2), the automation components 110, 112 and 116 (see FIG. 1) and/or a terminal equipment controller (TEC), other full function devices, a workstation 104, etc. within the control system 100. The wireless binding operation may be utilized to replace and/or augment traditional binding operations in which devices within the control system 100 are physically connected or wired together to define the networks 102, 108 and subnets 118a, 118b of the control system 100. Binding as used herein describes the logical and communications relationship between devices, components and elements within the control system 100.

At block 302, one or more of the automation components, for example, the automation components 200, 112 and 116, to be bound together or with other components, elements or subsystems of the control system 100 may be physically setup or emplaced within the structure. While all of the automation components 200, 112 and 116 may be utilized interchangeably with the teachings disclosed herein, the automation component 200 will be referred to herein for convenience and clarity. The physical setup may include mounting or otherwise positioning the automation component 200 within a given region or area or a structure to be monitored. For example, if the automation component 200 is a wireless room temperature sensor (WRTS), it may be positioned within an area of the structure in which the temperature is to be monitored. The physical setup may further include positioning or mounting the automation component 200 within a specific distance or range of another automation component 200 and/or other full function or reduced function devices operating within the control system 100. For example, in order to establish the subnet 118b, the automation component 200 may be positioned within two hundred feet (200 ft) or approximately sixty meters (60 m) of another component or device. The physical setup may further include: ensuring broadcast or line-of-site communications around the mounting position for the automation component 200, checking or monitoring the power source of the automation component 200, e.g., verifying the fuel cell, battery, line power, magnetic resonance receiver, etc.

At block 304, the basic configuration, logical setup or commissioning of the automation component 200 may be established. The basic configuration may include a network name or alias, a media access control (MAC) address, a network or subnet password, etc. In one embodiment, the automation component 200 may be configured with a list or database of information detailing the component's communication schedule, other devices or components in the control system 100 to which communications should be established, communications or information priorities, etc. The basic configuration may be accomplished by way of a direct, e.g., wired, infrared, etc., connection between a portable device such as a laptop or personal digital assistant. Alternatively, each automation component 200 may be assigned a unique identifier or identification such as a hexadecimal code or string. The unique identifier may allow a portable device to wirelessly communicate or connect with an automation component 200 that has not been fully configured by addressing commands or communications using the unique identifier. In this way, the portable device contacts the automation component 200 and provides the information, e.g., network alias, password, etc., necessary to complete the basic configuration.

At block 306, the portable device may connect to the automation component 200 and initiate a binding sequence between the component and one or more devices operating within the control system 100. For example, the portable device may be a laptop computer having a communications program such as, for example, WINDOWS® HyperTerminal or other man machine interface (MMI), into which a bind initiate command may be entered and provided to the automation component 200. The bind initiate command may include the network identifier, identification and/or alias of, for example, the terminal equipment controller, full function device or network, to which the automation component 200 is to be bound.

At block 308, the automation component 200, in response to the received bind initiate command, attempts to contact designated the terminal equipment controller, full function device or network. The communication attempt may query or challenge the designated device and upon receipt of a response establish a connection between the automation component 200 and the designated device. For example, the automation component 200 may initiate a handshake query or communication with the terminal equipment control to which it is to be bound. The handshake or challenge may be a timed communication such that a response must be received by the transmitting automation component 200 within a given time period, e.g., ten (10) seconds, or else the communication will be denied.

At block 310, the status of the communication attempt may be evaluated. If the communication is successful, e.g., the response was received within the allowed time period, the response includes the proper information, password, etc., and/or the response is provided in the proper format, then at block 312, the connection is established between the automation component 200 and the designated device. However, if the communication is not successful, e.g., the response was delayed, the response is incorrect or in provided in an improper format, then at block 314, the connection is not established and an error is generated. The error, in turn, may be communicated to the portable device and displayed via the HyperTerminal program. In another embodiment, the automation component 200 may include indicators such as, for example, light emitting diodes (LEDs) to provide a visual indication of successful or failed communication attempts.

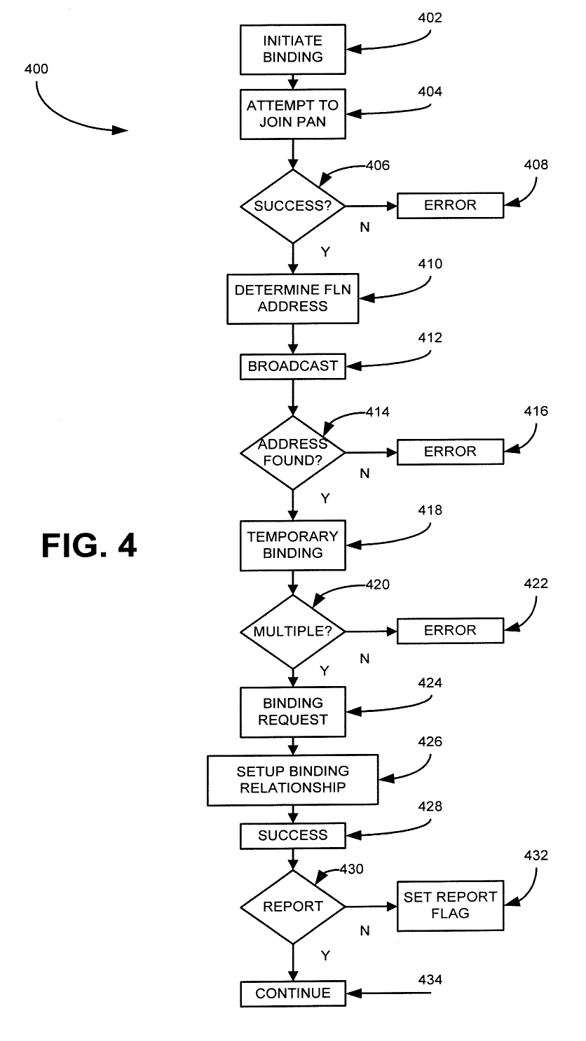

FIG. 4 illustrates an embodiment of a wireless binding operation or procedure 400 that may be implemented between one or more of the exemplary automation components 200 (see FIG. 2), the automation components 110, 112 and 116 (see FIG. 1) and/or a terminal equipment controller (TEC), other full function devices, a workstation 104, etc. within the control system 100. In this exemplary embodiment, it is assumed that the automation component 200 has been powered up and configured with the basic information, passwords, etc. necessary to successfully perform the binding operation.

At block 402, the binding sequence may be initiated by sending a bind command to the man machine interface (MMI) of the automation component 200, e.g., the automation component to be bound to one or more of the networks 102, 108, 118, etc. As previously discussed, the bind command may be provided via communications program executing on a portable device in communication with the automation component 200. The bind command may include an address or identifier of the floor level network (FLN) or full function device to which the automation component 200 is to bind.

At block 404, the automation component 200 may attempt to join a personal area network (PAN). For example, the automation component 200 may attempt to join the PAN of a field panel transceiver (FPX) or floor level data transceiver (FLNX) positioned locally, i.e., nearby. The subsequent PAN of the field panel transceiver and the automation component 200 may form, for example, the subnet 118b.

At block 406, the status of the communication attempt may be evaluated. If the communication is not successful, i.e., the automation component 200 cannot communicate or join the personal area network, then at block 408, an error may be generated. The error, in turn, may be communicated to the portable device and displayed via the HyperTerminal program. However, if the communication is successful and the automation component 200 is able to join the personal area network, then at block 410, the automation component prepares a binding request or signal that includes the address pattern of the floor level network automation component designated or provided with the initial bind command.

At block 412, the automation component 200 generates and transmits a broadcast message. The broadcast message is communicated to each floor level device transceiver (FLNX) and/or full function devices within a given area or region of the structure, e.g., a specific transmission area. An FLNX or other full function device that receives the broadcast message but does not match the specified address pattern will ignore or otherwise not respond to the message.

At block 414, the status of the broadcast message attempt may be evaluated. If the broadcast message is not successful because an FLNX or other full function device is not assigned the sought after address, then at block 416 the broadcast message will timeout as unanswered. However, if the broadcast message is received by the FLNX or other full function device assigned the correct address, then at block 418, the FLNX will broadcast a response or message back to the automation component 200. The response or message broadcast to the automation component 200 may include a temporary binding or code. The temporary binding or code may be associated with a timer or time period such as, for example, ten seconds (10 sec), after which the temporary binding or code may no longer be valid or used.

At block 420, the automation component 200 determines if multiple temporary bindings or codes have been received from one or more floor level device transceivers in range of the original broadcast message or binding request. If multiple temporary binding or codes have been received, then at block 422, the automation component 200 generates an error message which can be communicated to the portable device and displayed via the communications or HyperTerminal program. However, if multiple temporary bindings or codes have not been received within a given time period such as, for example, five seconds (5 sec), then at block 424, the automation component 200 can communicate a bind request to the FLNX or full function device that responded to the original broadcast message. The automation component 200 may communicate the bind request multiple times, for example, once every two seconds (2 sec), in order to establish communications between the two devices.

At block 426, the FLNX or full function device, upon receiving the bind request, deletes any previous binding relationships established for the automation component 200. The FLNX or full function device will, in turn, stored the MAC address or logical identifier associated with the automation component 200. The stored MAC address or logical identifier can be saved or stored in a memory such as an EEPROM or other erasable non-volatile memory. Similarly, the FLNX or full function device will communicate a bind request back to the automation component 200 which, in turn, will establish a binding relationship with the full function device. If the temporary binding or code remains present from previous communications with the FLNX or full function device, the temporary binding can be converted to establish a permanent binding relationship.

At block 428, a success message or indication may be generated by the man machine interface (MMI) of the automation component 200. The success indication may be communicated to the portable device and displayed via the HyperTerminal program. In another embodiment, on or more light emitting diodes (LEDs) on the automation component 200 may be utilized to indicate the successful completion of the binding. If the binding relationship is not successfully established, but a previous binding relationship between the FLNX or full function device and the automation component 200 has been established, the previous binding relationship may not be deleted or erased allowing the automation component 200 to communicate with the appropriate network for example, the networks 102, 108 and 118.

At block 430, the automation component 200 may generate a report that includes the configuration parameters associated therewith. The generated report may then be communicated via the newly established binding relationship to the FLNX or full function device. If no response or acknowledgement is received from the FLNX or full function device after one or more communication attempts, then at block 432 a reporting flag can be enabled or set. The reporting flag indicates that whenever the automation component 200 “wakes up” or is otherwise activated to perform one or more assigned tasks, another communication attempt will be made to provide the report to the FLNX or full function device. The reporting flag and the repeated communications can remain active at least until an appropriate acknowledgment is received from the FLNX or full function device.

At block 434, the configured and bound automation component 200 begins and/or continues operation within the network to which it has been bound. For example, if the automation component 200 is a wireless room temperature sensor (WRTS), then the automation component 200 can begin monitoring and providing temperature readings for an area, region or portion of the structure.

In an alternate embodiment, the broadcast message communicated at the block 412 can include the effective user identification (EUID) or media access control (MAC) address of the FLNX or full function device. The effective user identification (EUID) or media access control (MAC) address may, in turn, be utilized by the FLNX or full function device as described above to establish a binding relationship with the automation component 200.

In yet another alternate embodiment, the broadcast message communicated at the block 412 can be initiated in response to, for example, a push button or other command disposed or provided on both the automation component 200 and the FLNX or full function device. For example, by depressing a binding push button on the automation component 200 and a binding push button on the FLNX or full function device, both devices can be configured to broadcast their media access control (MAC) addresses and/or their floor level network (FLN) address. Each device, upon receipt of the broadcast information, can, in turn, establish a binding relationship based on the received information.

In yet another embodiment, the automation component 200 may include a switch, toggle or other device that may be utilized to manually provide the media access control (MAC) addresses and/or their floor level network (FLN) address of the FLNX or full function device to which communications is desired. In this way, a user may manually enter or provide the communication information necessary to bind the automation component 200 to the FLNX or full function device. The automation component 200 may, for example, upon power-up broadcast a binding request directly to the FLNX or full function device utilizing the provided address information.

In yet another embodiment, the automation component 200 may broad cast a discovery message to all floor level device transceivers (FLNX) within a given reception area. Each FLNX or full function device within the reception area can, in turn, respond with a message that includes a media access control (MAC) addresses and/or their floor level network (FLN) address. The automation component 200 may receive each of the response messages and select the FLNX or full function device that provided the message with the greatest signal strength. Upon selection of a given FLNX or full function device, a visual or audio indication may be provided to allow a user to initiate a push button or other binding operation between the two devices.

It should be understood that various changes and modifications to the presently preferred embodiments described herein will be apparent to those skilled in the art. For example, the elements of these configurations could be arranged and interchanged in any known manner depending upon the system requirements, performance requirements, and other desired capabilities. Well understood changes and modifications can be made based on the teachings and disclosure provided by the present invention and without diminishing from the intended advantages disclosed herein. It is therefore intended that such changes and modifications be covered by the appended claims.

What is claimed is:

1. An automation component configured for wireless communication within a building automation system, the automation component comprising:
a wireless communications component;
a processor in communication with the wireless communications component;
a memory in communication with the processor, the memory configured to store computer readable instructions which are executable by the processor; wherein the computer readable instructions are programmed to:
generate a binding request including a device identifier;
broadcast the binding request via the wireless communications component; and
establish a binding relationship based on a received response to the binding request.

2. The automation component of claim 1, wherein the device identifier is selected from the group consisting of: a logical identifier; an internet protocol address; a media access control address; and a local network address.

3. The automation component of claim 1, wherein the computer readable instructions are further programmed to:
establish a temporary binding relationship based on an initial received response to the binding request

4. The automation component of claim 1, wherein the computer readable instructions are further programmed to:
generate a personal area network binding request having a device identifier; and
establish a personal area network binding relationship based on a received response to the binding personal area network.

5. The automation component of claim 1, wherein the memory is configured to store a man-machine interface.

6. A method for binding an automation component within a building automation system, the method comprising:
communicating a binding request via a wireless communication link wherein the binding request includes a device identifier;
receiving a binding response via the wireless communication link; and
establishing a binding relationship based on the received binding response.

7. The method of claim 6, wherein communicating a binding request including broadcasting the binding request.

8. The method of claim 6, wherein communicating the binding request further comprises:
communicating the included device identifier selected from the group consisting of: a logical identifier; an internet protocol address; a media access control address; and a local network address.

9. The method of claim 6 further comprising:
establishing a temporary binding relationship based on an initial received response to the binding request.

10. The method of claim 6 further comprising:
communicating a personal area network binding request having a device identifier; and
establishing a personal area network binding relationship based on a received response to the binding personal area network.

11. The method of claim 6 further comprising:
configuring the binding request via a man-machine interface.

12. An automation component configured for wireless communication within a building automation system, the automation component comprising:
a processor configured to generate a binding request including a device identifier;
a wireless transmitter configured to wirelessly broadcast the binding request to a second automation component; and
a receiver configured to receive a binding response communicated from the second automation component;
wherein a binding relationship is established with the second automation component based on the received response.

13. The automation component of claim 12, wherein the device identifier is selected from the group consisting of: a logical identifier; an internet protocol address; a media access control address; and a local network address.

14. The automation component of claim 12, wherein the processor is further configured to generate a temporary binding relationship based on an initial received response to the binding request

15. The automation component of claim 12, wherein the processor is further configured to generate a personal area network binding request having a device identifier and establish a personal area network binding relationship based on a received response to the binding personal area network.

16. The automation component of claim 12 further comprising a man-machine interface.
